(19) United States
(12) Patent Application Publication
(10) Pub. No.: US 2026/0052453 A1
(43) Pub. Date: Feb. 19, 2026

(54) METHOD AND APPARATUS FOR SUPPORTING AERIAL MOBILITY IN MOBILE IAB NETWORKS

(71) Applicant: LG ELECTRONICS INC., Seoul (KR)

(72) Inventors: Daewook BYUN, Seoul (KR); Seokjung KIM, Seoul (KR)

(73) Assignee: LG ELECTRONICS INC., Seoul (KR)

(21) Appl. No.: 19/103,793

(22) PCT Filed: Mar. 16, 2023
(86) PCT No.: PCT/KR2023/003513

§ 371 Date: Feb. 13, 2025

Related U.S. Application Data
(60) Provisional application No. 63/407,171, filed on Sep. 16, 2022.

(51) Int. Cl. H04W 40/24; H04L 5/00; H04W 8/22; H04W 76/20; H04W 84/06

(52) U.S. Cl. CPC H04W 40/248; H04L 5/0053; H04W 8/22; H04W 76/20; H04W 84/06

(57) ABSTRACT

A method and apparatus for supporting aerial mobility in mobile IAB networks is provided. The LAB-CU receives information on an UAV Capability of the mobile IAB-node. The IAB-CU transmits a UE Context Setup Request message including information on a flying state for a UE. The IAB-CU receives a gNB-DU Configuration Update message including information on whether the mobile IAB-node is in flight. The IAB-CU transmits, to the UE through the mobile IAB-node, (i) an RRC message including a measurement stop indication, and/or (2) an RRC message without information related to measurements.

### CROSS-REFERENCE TO RELATED APPLICATION(S)

This application is the National Stage filing under 35 U.S.C. 371 of International Application No. PCT/KR2023/003513, filed on Mar. 16, 2023, which claims the benefit of U.S. Provisional Application No. 63/407,171, filed on Sep. 16, 2022, the contents of which are all incorporated by reference herein in their entirety.

### TECHNICAL FIELD

The present disclosure relates to a method and apparatus for supporting aerial mobility in mobile Integrated Access and Backhaul (IAB) networks.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

Considering the mobile IAB-node supporting the Uncrewed Aerial Vehicle (UAV) feature, while the mobile IAB-node is in flight, the wireless devices receiving services through the mobile IAB-node are affected by interference from more base stations than when they are on the ground. Therefore, the downlink and uplink throughput of the wireless devices are degraded.

In addition, since the wireless devices receiving service through the mobile IAB-node cannot perform altitude-based measurements, there is no way to inform the base station that they are in flight.

In addition, the wireless devices receiving service through the mobile IAB-node can measure a cell with a temporarily strong signal during flight. If the measurement results are reported to the base station, the base station can perform Autonomous Neighbor Relationship (ANR) based on this. As a result, the base station can have an invalid Neighbor Relationship Table (NRT).

Therefore, a method for improving the downlink and uplink throughput of a wireless device belonging to a mobile IAB-node having a UAV feature is required. In addition, a method is needed to prevent a base station from having erroneous NRT by not performing measurements during flight.

That is, studies for supporting aerial mobility in mobile IAB networks are required.

In an aspect, a method performed by an Integrated Access and Backhaul (IAB)-donor-Central Unit (CU) in a wireless communication system is provided. The method comprises: initiating an integration procedure with a mobile IAB-node; performing an IAB-MT setup procedure with the mobile IAB-node; performing a backhaul radio link control (BH RLC) channel establishment with the mobile IAB-node; performing a routing update with the mobile IAB-node; performing an IAB-Distributed Unit (DU) setup procedure with the mobile IAB-node; receiving, from the mobile IAB-node, information on an Unmanned Aerial Vehicle (UAV) Capability of the mobile IAB-node, in the integration procedure; transmitting, to the mobile IAB-node, a UE Context Setup Request message including information on a flying state for a UE; receiving, from the mobile IAB-node, a gNB-DU Configuration Update message including information on whether the mobile IAB-node is in flight; and transmitting, to the UE through the mobile IAB-node, (i) an RRC message including a measurement stop indication, and/or (2) an RRC message without information related to measurements.

In another aspect, an apparatus for implementing the above method is provided.

The present disclosure can have various advantageous effects.

According to some embodiments of the present disclosure, an Integrated Access and Backhaul (IAB) donor could efficiently support aerial mobility of a mobile IAB-node in wireless communication system.

For example, a wireless device may handover to a mobile IAB-node having UAV capability. When the mobile IAB-node starts moving, the wireless device belonging to the mobile IAB-node may not perform measurement of cells. The IAB-donor-CU or mobile IAB-node may generate a flying state for the corresponding wireless device and provide it to the mobile IAB-node or IAB-donor-CU.

When IAB-donor-CU recognizes the start of mobile IAB-node movement, the IAB-donor-CU may (1) transmit an RRC message with an indicator so that the UE does not perform measurement, or (2) transmit an RRC message with measurement-related information removed.

Through this method, the downlink and uplink throughput of the wireless device can be improved. In addition, by preventing the wireless device from performing measurement while belonging to the mobile IAB-node, it is possible to prevent base stations from having erroneous NRT.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows an example of UE to which implementations of the present disclosure is applied.

FIGS. 5 and 6 show an example of protocol stacks in a 3GPP based wireless communication system to which implementations of the present disclosure is applied.

FIG. 7 shows an example of the overall architecture of an NG-RAN to which technical features of the present disclosure can be applied.

FIG. 8 shows an interface protocol structure for F1-C to which technical features of the present disclosure can be applied.

FIG. 9 shows a reference diagram for IAB in standalone mode, which contains one IAB-donor and multiple IAB-nodes, to which the technical features of the present disclosure can be applied.

FIG. 10 shows an example of overall architecture of IAB to which the technical features of the present disclosure can be applied.

FIG. 11 shows an integration procedure for IAB-node in System Aspects (SA) to which implementations of the present disclosure is applied.

FIG. 12 shows a successful operation of an F1 Setup procedure to which implementations of the present disclosure is applied.

FIG. 13 shows an unsuccessful operation of an F1 Setup procedure to which implementations of the present disclosure is applied.

FIG. 14 shows a successful operation of a gNB-DU configuration update procedure to which implementations of the present disclosure is applied.

FIG. 15 shows a unsuccessful operation of a gNB-DU configuration update procedure to which implementations of the present disclosure is applied.

FIG. 16 shows a successful operation of a UE Context setup request procedure to which implementations of the present disclosure is applied.

FIG. 17 shows an unsuccessful operation of a UE Context setup request procedure to which implementations of the present disclosure is applied.

FIG. 18 shows a DL RRC Message Transfer procedure to which implementations of the present disclosure is applied.

FIG. 19 shows an example of a method for supporting aerial mobility in mobile IAB networks, according to some embodiments of the present disclosure.

FIGS. 20a and 20b show an example of an Xn Handover procedure toward a mobile IAB-node with UAV capability and a procedure when the mobile IAB-node with UAV capability begins to fly.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

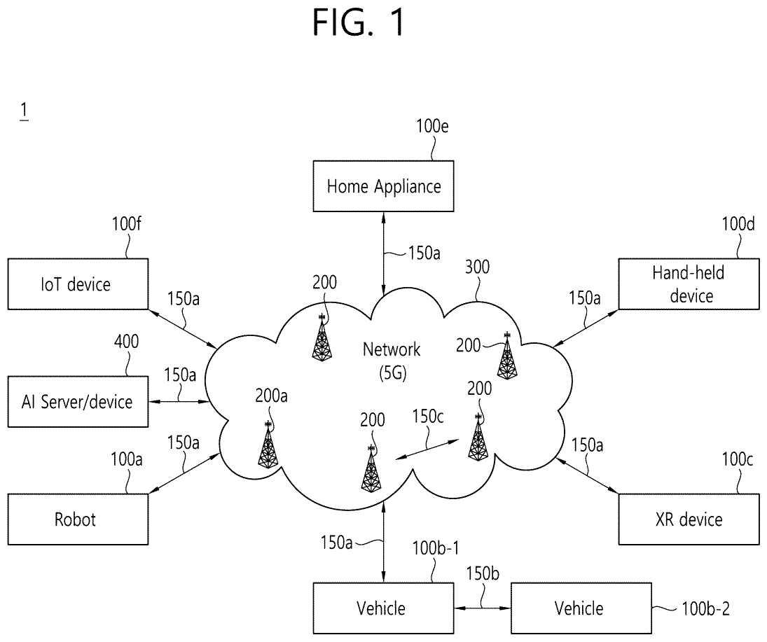

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

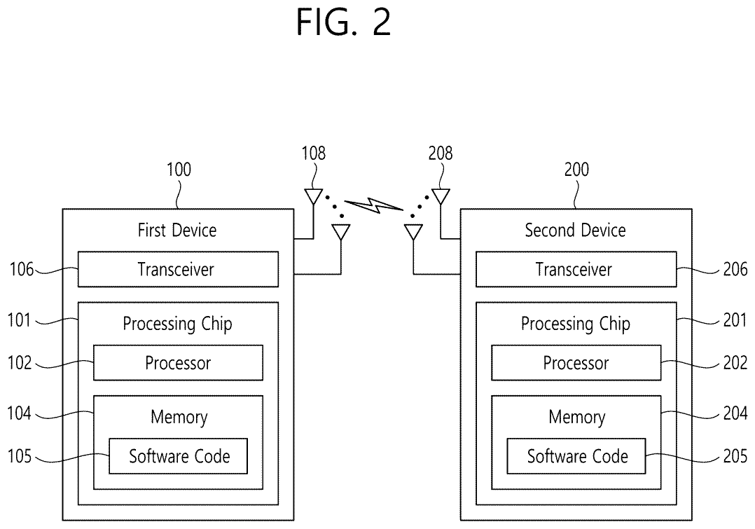

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

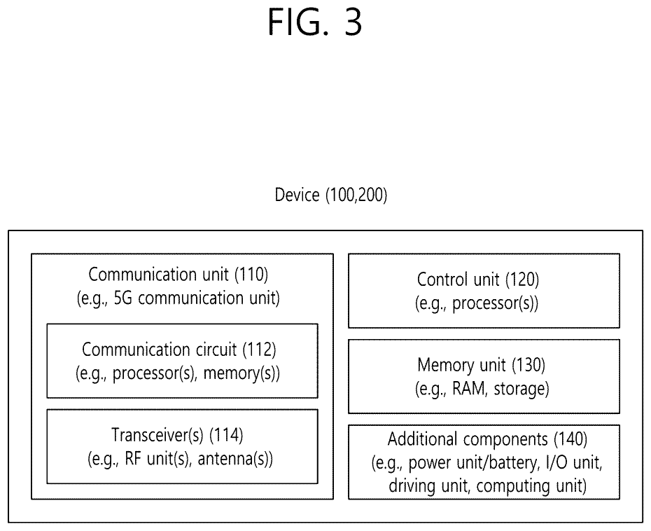

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

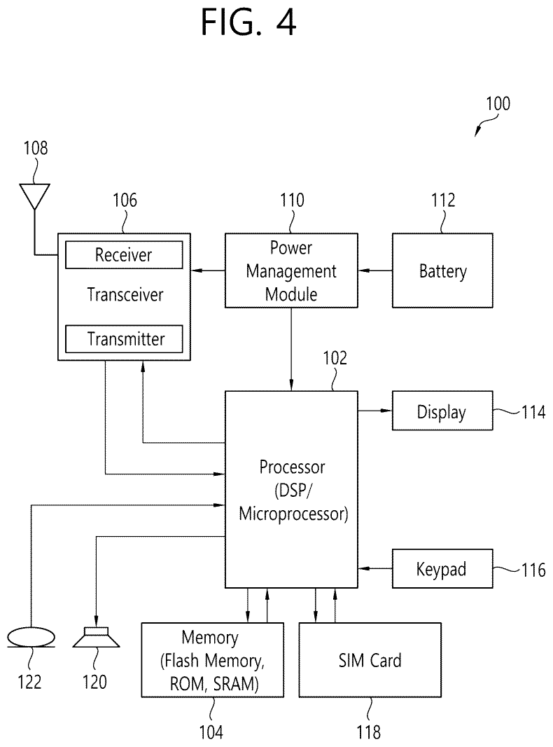

FIG. 4 shows an example of UE to which implementations of the present disclosure is applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 110, a battery 112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 116 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

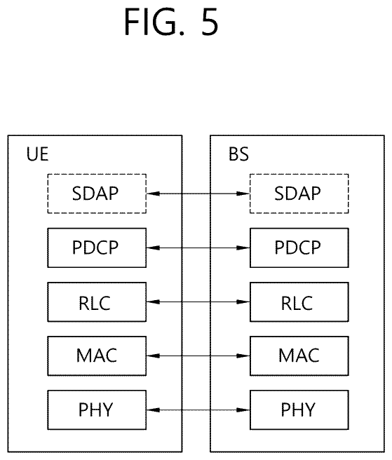

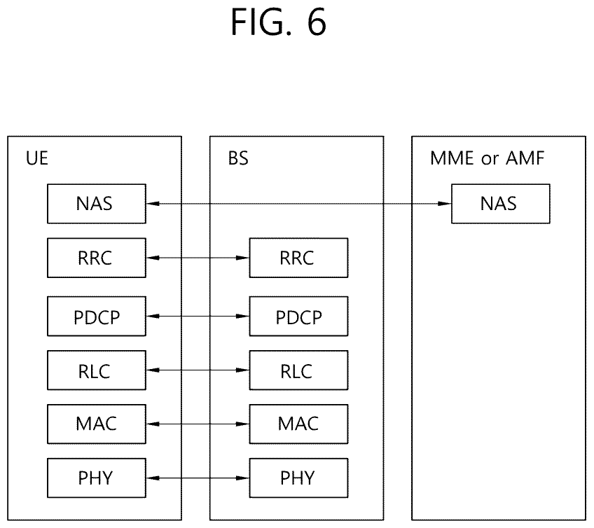

FIGS. 5 and 6 show an example of protocol stacks in a 3GPP based wireless communication system to which implementations of the present disclosure is applied.

In particular, FIG. 5 illustrates an example of a radio interface user plane protocol stack between a UE and a BS and FIG. 6 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 5, the user plane protocol stack may be divided into Layer 1 (i.e., a PHY layer) and Layer 2. Referring to FIG. 6, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

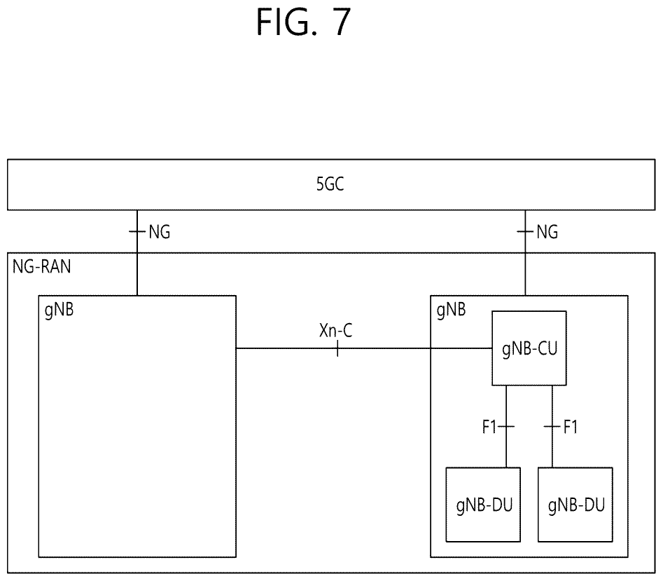

FIG. 7 shows an example of the overall architecture of an NG-RAN to which technical features of the present disclosure can be applied.

Referring to FIG. 7, a gNB may include a gNB-CU (hereinafter, gNB-CU may be simply referred to as CU) and at least one gNB-DU (hereinafter, gNB-DU may be simply referred to as DU).

The gNB-CU is a logical node hosting RRC, SDAP and PDCP protocols of the gNB or an RRC and PDCP protocols of the en-gNB. The gNB-CU controls the operation of the at least one gNB-DU.

The gNB-DU is a logical node hosting RLC, MAC, and physical layers of the gNB or the en-gNB. The operation of the gNB-DU is partly controlled by the gNB-CU. One gNB-DU supports one or multiple cells. One cell is supported by only one gNB-DU.

The gNB-CU and gNB-DU are connected via an F1 interface. The gNB-CU terminates the F1 interface connected to the gNB-DU. The gNB-DU terminates the F1 interface connected to the gNB-CU. One gNB-DU is connected to only one gNB-CU. However, the gNB-DU may be connected to multiple gNB-CUs by appropriate implementation. The F1 interface is a logical interface. For NG-RAN, the NG and Xn-C interfaces for a gNB consisting of a gNB-CU and gNB-DUs, terminate in the gNB-CU. For E-UTRAN-NR dual connectivity (EN-DC), the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

Functions of the F1 interface includes F1 control (F1-C) functions as follows.

### (1) F1 Interface Management Function

The error indication function is used by the gNB-DU or gNB-CU to indicate to the gNB-CU or gNB-DU that an error has occurred.

The reset function is used to initialize the peer entity after node setup and after a failure event occurred. This procedure can be used by both the gNB-DU and the gNB-CU.

The F1 setup function allows to exchange application level data needed for the gNB-DU and gNB-CU to interoperate correctly on the F1 interface. The F1 setup is initiated by the gNB-DU.

The gNB-CU configuration update and gNB-DU configuration update functions allow to update application level configuration data needed between gNB-CU and gNB-DU to interoperate correctly over the F1 interface, and may activate or deactivate cells.

The F1 setup and gNB-DU configuration update functions allow to inform the single network slice selection assistance information (S-NSSAI) supported by the gNB-DU.

The F1 resource coordination function is used to transfer information about frequency resource sharing between gNB-CU and gNB-DU.

### (2) System Information Management Function

Scheduling of system broadcast information is carried out in the gNB-DU. The gNB-DU is responsible for transmitting the system information according to the scheduling parameters available.

The gNB-DU is responsible for the encoding of NR master information block (MIB). In case broadcast of system information block type-1 (SIB1) and other SI messages is needed, the gNB-DU is responsible for the encoding of SIB1 and the gNB-CU is responsible for the encoding of other SI messages.

### (3) F1 UE Context Management Function

The F1 UE context management function supports the establishment and modification of the necessary overall UE context.

The establishment of the F1 UE context is initiated by the gNB-CU and accepted or rejected by the gNB-DU based on admission control criteria (e.g., resource not available).

The modification of the F1 UE context can be initiated by either gNB-CU or gNB-DU. The receiving node can accept or reject the modification. The F1 UE context management function also supports the release of the context previously established in the gNB-DU. The release of the context is triggered by the gNB-CU either directly or following a request received from the gNB-DU. The gNB-CU request the gNB-DU to release the UE Context when the UE enters RRC IDLE or RRC INACTIVE.

This function can be also used to manage DRBs and SRBs, i.e., establishing, modifying and releasing DRB and SRB resources. The establishment and modification of DRB resources are triggered by the gNB-CU and accepted/rejected by the gNB-DU based on resource reservation information and QoS information to be provided to the gNB-DU. For each DRB to be setup or modified, the S-NSSAI may be provided by gNB-CU to the gNB-DU in the UE context setup procedure and the UE context modification procedure.

The mapping between QoS flows and radio bearers is performed by gNB-CU and the granularity of bearer related management over F1 is radio bearer level. For NG-RAN, the gNB-CU provides an aggregated DRB QoS profile and QoS flow profile to the gNB-DU, and the gNB-DU either accepts the request or rejects it with appropriate cause value. To support packet duplication for intra-gNB-DU carrier aggregation (CA), one data radio bearer should be configured with two GPRS tunneling protocol (GTP)-U tunnels between gNB-CU and a gNB-DU.

With this function, gNB-CU requests the gNB-DU to setup or change of the special cell (SpCell) for the UE, and the gNB-DU either accepts or rejects the request with appropriate cause value.

With this function, the gNB-CU requests the setup of the secondary cell(s) (SCell(s)) at the gNB-DU side, and the gNB-DU accepts all, some or none of the SCell(s) and replies to the gNB-CU. The gNB-CU requests the removal of the SCell(s) for the UE.

### (4) RRC Message Transfer Function

This function allows to transfer RRC messages between gNB-CU and gNB-DU. RRC messages are transferred over F1-C. The gNB-CU is responsible for the encoding of the dedicated RRC message with assistance information provided by gNB-DU.

### (5) Paging Function

The gNB-DU is responsible for transmitting the paging information according to the scheduling parameters provided.

The gNB-CU provides paging information to enable the gNB-DU to calculate the exact paging occasion (PO) and paging frame (PF). The gNB-CU determines the paging assignment (PA). The gNB-DU consolidates all the paging records for a particular PO, PF and PA, and encodes the final RRC message and broadcasts the paging message on the respective PO, PF in the PA.

### (6) Warning Messages Information Transfer Function

This function allows to cooperate with the warning message transmission procedures over NG interface. The gNB-CU is responsible for encoding the warning related SI message and sending it together with other warning related information for the gNB-DU to broadcast over the radio interface.

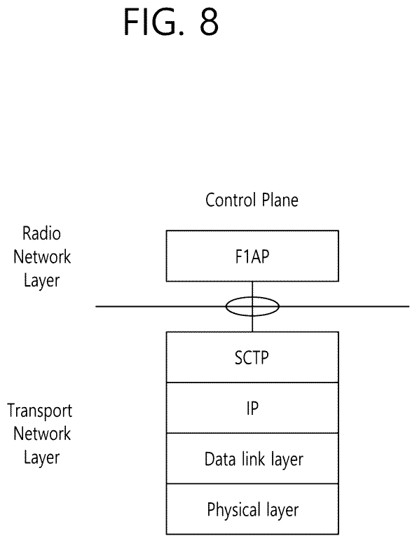

FIG. 8 shows an interface protocol structure for F1-C to which technical features of the present disclosure can be applied.

A transport network layer (TNL) is based on Internet protocol (IP) transport, comprising a stream control transmission protocol (SCTP) layer on top of the IP layer. An application layer signaling protocol is referred to as an F1 application protocol (E1AP).

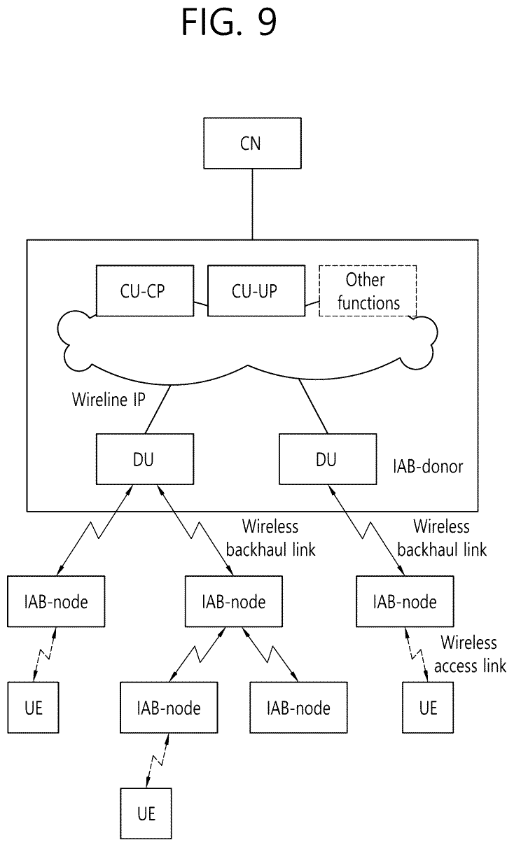

FIG. 9 shows a reference diagram for IAB in standalone mode, which contains one IAB-donor and multiple IAB-nodes, to which the technical features of the present disclosure can be applied.

The IAB-donor is treated as a single logical node that comprises a set of functions such as gNB-DU, gNB-CU control plane (gNB-CU-CP), gNB-CU user plane (gNB-CU-UP) and potentially other functions. In a deployment, the IAB-donor can be split according to these functions, which can all be either collocated or non-collocated as allowed by 3GPP NG-RAN architecture. IAB-related aspects may arise when such split is exercised. Also, some of the functions presently associated with the IAB-donor may eventually be moved outside of the donor in case it becomes evident that they do not perform IAB-specific tasks.

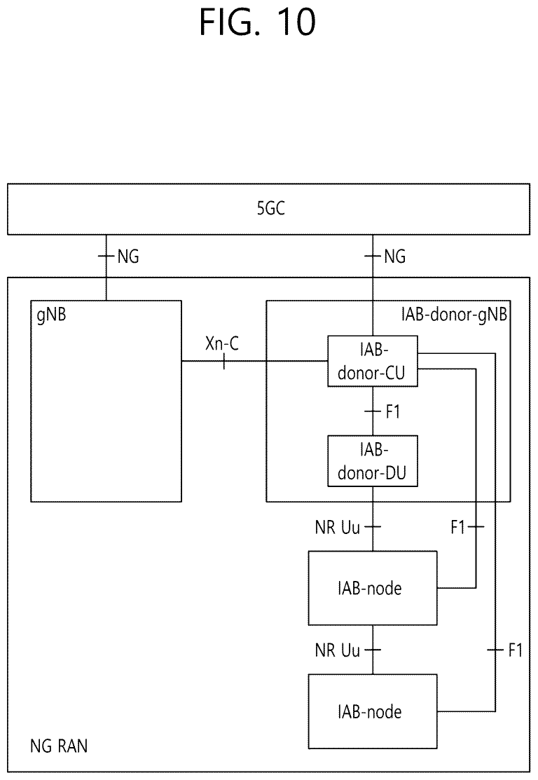

FIG. 10 shows an example of overall architecture of IAB to which the technical features of the present disclosure can be applied.

The NG-RAN supports IAB by the IAB-node wirelessly connecting to the gNB capable of serving the IAB-nodes, named IAB-donor gNB.

The IAB-donor gNB consists of an IAB-donor-CU and one or more IAB-donor-DU(s). In case of separation of gNB-CU-CP and gNB-CU-UP, the IAB-donor gNB may consist of an IAB-donor-CU-CP, multiple IAB-donor-CU-UPs and multiple IAB-donor-DUs.

The IAB-node connects to an upstream IAB-node or an IAB-donor-DU via a subset of the UE functionalities of the NR Uu interface (named IAB-MT function of IAB-node). The IAB-node provides wireless backhaul to the downstream IAB-nodes and UEs via the network functionalities of the NR Uu interface (named IAB-DU function of IAB-node).

The F1-C traffic towards an IAB-node is backhauled via the IAB-donor-DU and the optional intermediate IAB-node(s).

The F1 user plane interface (F1-U) traffic towards an IAB-node is backhauled via the IAB-donor-DU and the optional intermediate IAB-node(s).

All functions specified for a gNB-DU are equally applicable for an IAB-node and IAB-donor-DU unless otherwise stated, and all functions specified for a gNB-CU are equally applicable for an IAB-donor-CU, unless otherwise stated. All functions specified for the UE context are equally applicable for managing the context of IAB-node MT functionality, unless otherwise stated.

Hereinafter, technical features related to standalone IAB integration are described. Section 8.12.1 of 3GPP TS 38.401 v17.1.1 may be referred.

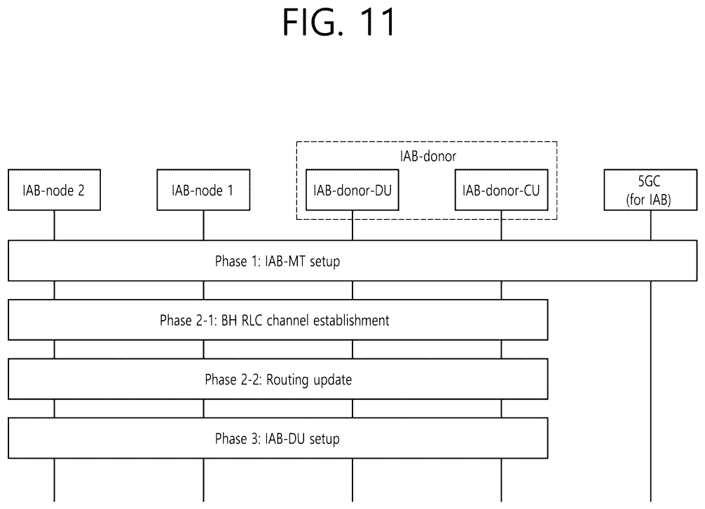

FIG. 11 shows an integration procedure for IAB-node in System Aspects (SA) to which implementations of the present disclosure is applied.

In particular, in FIG. 11, a high-level flow chart for SA-based IAB integration is illustrated.

Phase 1: IAB-MT setup. In this phase, the IAB-MT of the new IAB-node (e.g. IAB-node 2 in FIG. 11) connects to the network in the same way as a UE, by performing RRC connection setup procedure with IAB-donor-CU, authentication with the core network, IAB-node 2-related context management, IAB-node 2's access traffic-related radio bearer configuration at the RAN side (SRBs and optionally DRBs), and, optionally, OAM connectivity establishment by using the IAB-MT's PDU session. The IAB-node can select the parent node for access based on an over-the-air indication from potential parent node IAB-DU (transmitted in SIB1). To indicate its IAB capability, the IAB-MT includes the IAB-node indication in RRCSetupComplete message, to assist the IAB-donor to select an AMF supporting IAB.

The signalling flow for UE initial access procedure is used for the setup of the IAB-MT.

Phase 2-1: BH RLC channel establishment. During the bootstrapping procedure, one default BH RLC channel for non-UP traffic e.g. carrying F1-C traffic/non-F1 traffic to and from the IAB-node 2 in the integration phase, is established. This may require the setup of a new BH RLC channel or modification of an existing BH RLC channel between IAB-node 1 and IAB-donor-DU. The IAB-donor-CU may establish additional (non-default) BH RLC channels. This phase also includes configuring the BAP Address of the IAB-node 2 and default BAP Routing ID for the upstream direction.

If the OAM connectivity is supported via backhaul IP layer by implementation, one or more BH RLC channels used for OAM traffic can also be established.

Phase 2-2: Routing update. In this phase, the BAP sublayer is updated to support routing between the new IAB-node 2 and the IAB-donor-DU. For the downstream direction, the IAB-donor-CU initiates F1AP procedure to configure the IAB-donor-DU with the mapping from IP header field(s) to the BAP Routing ID related to IAB-node 2. The routing tables are updated on all ancestor IAB-nodes (e.g. IAB-node 1 in FIG. 11) and on the IAB-donor-DU, with routing entries for the new BAP Routing ID(s). This phase may also include the IP address allocation procedure for IAB-node 2. IAB-node 2 may request one or more IP addresses from the IAB-donor-CU via RRC. The IAB-donor-CU may send the IP address(es) to the IAB-node 2 via RRC. The IAB-donor-CU may obtain the IP address(es) from the IAB-donor-DU via F1-AP or by other means (e.g. OAM, DHCP). IP address allocation procedure may occur at any time after RRC connection has been established.

Phase 3: IAB-DU part setup. In this phase, the IAB-DU of IAB-node 2 is configured via OAM. The IAB-DU of IAB-node 2 initiates the TNL establishment, and F1 setup (as defined in clause 8.5) with the IAB-donor-CU using the allocated IP address(es). The IAB-donor-CU discovers collocation of IAB-MT and IAB-DU from the IAB-node's BAP Address included in the F1 SETUP REQUEST message. After the F1 is set up, the IAB-node 2 can start serving the UEs.

The IAB-DU can discover the IAB-donor-CU's IP address in the same manner as a non-IAB gNB-DU.

If the IAB-node establishes NR-DC before the establishment of F1-C connection, the MN decides whether the MN or the SN becomes the F1-terminating IAB-donor. In case it decides that the SN becomes the F1-terminating IAB-donor, it notifies the SN via Xn (Phases 2.1 and 2.2). The IAB-node can implicitly derive whether the MN or the SN is the F1-terminating IAB-donor, e.g., based on the entity which provides the default BAP configuration.

For OAM-based IAB-donor selection, if the IAB-node establishes NR-DC before the establishment of F1-C connection, the IAB-node indicates the F1-terminating IAB-donor by signaling its IP address(es) to this IAB-donor via RRC signaling.

Hereinafter, technical features related to F1 setup are described. Section 8.2.3 of 3GPP TS 38.473 v17.1.0 may be referred.

The purpose of the F1 Setup procedure is to exchange application level data needed for the gNB-DU and the gNB-CU to correctly interoperate on the F1 interface. This procedure shall be the first F1AP procedure triggered for the F1-C interface instance after a TNL association has become operational.

If F1-C signalling transport is shared among multiple F1-C interface instances, one F1 Setup procedure is issued per F1-C interface instance to be setup, i.e. several F1 Setup procedures may be issued via the same TNL association after that TNL association has become operational.

Exchange of application level configuration data also applies between the gNB-DU and the gNB-CU in case the DU does not broadcast system information other than for radio frame timing and SFN. How to use this information when this option is used is not explicitly specified.

The procedure uses non-UE associated signalling.

This procedure erases any existing application level configuration data in the two nodes and replaces it by the one received. This procedure also re-initialises the F1AP UE-related contexts (if any) and erases all related signalling connections in the two nodes like a Reset procedure would do.

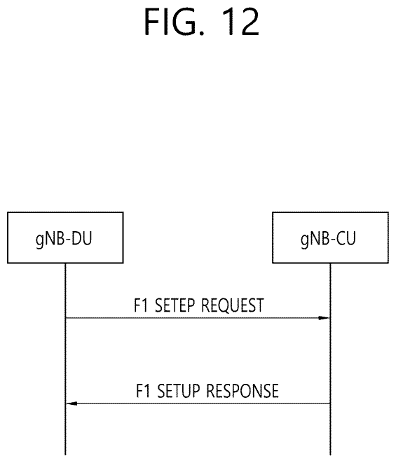

FIG. 12 shows a successful operation of an F1 Setup procedure to which implementations of the present disclosure is applied.

In FIG. 12, the gNB-DU initiates the procedure by sending a F1 SETUP REQUEST message including the appropriate data to the gNB-CU. The gNB-CU responds with a F1 SETUP RESPONSE message including the appropriate data.

The exchanged data shall be stored in respective node and used as long as there is an operational TNL association. When this procedure is finished, the F1 interface is operational and other F1 messages may be exchanged.

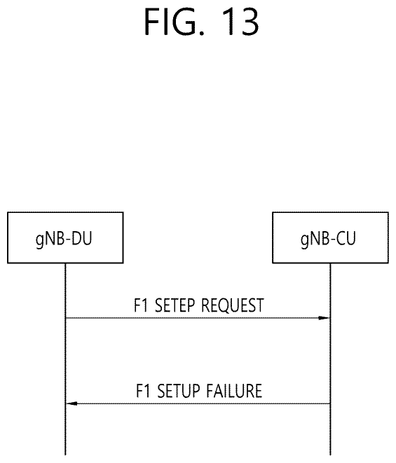

FIG. 13 shows an unsuccessful operation of an F1 Setup procedure to which implementations of the present disclosure is applied.

In FIG. 13, if the gNB-CU cannot accept the setup, it should respond with a F1 SETUP FAILURE and appropriate cause value.

If the F1 SETUP FAILURE message includes the Time To Wait IE, the gNB-DU shall wait at least for the indicated time before reinitiating the F1 setup towards the same gNB-CU.

Hereinafter, technical features related to gNB-DU configuration update are described. Section 8.2.4 of 3GPP TS 38.473 v17.1.0 may be referred.

The purpose of the gNB-DU Configuration Update procedure is to update application level configuration data needed for the gNB-DU and the gNB-CU to interoperate correctly on the F1 interface. This procedure does not affect existing UE-related contexts, if any. The procedure uses non-UE associated signalling.

Update of application level configuration data also applies between the gNB-DU and the gNB-CU in case the DU does not broadcast system information other than for radio frame timing and SFN. How to use this information when this option is used is not explicitly specified.

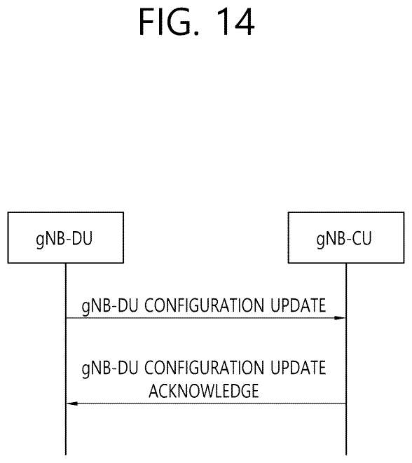

FIG. 14 shows a successful operation of a gNB-DU configuration update procedure to which implementations of the present disclosure is applied.

In FIG. 14, the gNB-DU initiates the procedure by sending a GNB-DU CONFIGURATION UPDATE message to the gNB-CU including an appropriate set of updated configuration data that it has just taken into operational use. The gNB-CU responds with GNB-DU CONFIGURATION UPDATE ACKNOWLEDGE message to acknowledge that it successfully updated the configuration data. If an information element is not included in the GNB-DU CONFIGURATION UPDATE message, the gNB-CU shall interpret that the corresponding configuration data is not changed and shall continue to operate the F1-C interface with the existing related configuration data.

The updated configuration data shall be stored in both nodes and used as long as there is an operational TNL association or until any further update is performed.

If gNB-DU ID IE is contained in the GNB-DU CONFIGURATION UPDATE message for a newly established SCTP association, the gNB-CU will associate this association with the related gNB-DU.

If Served Cells To Add Item IE is contained in the GNB-DU CONFIGURATION UPDATE message, the gNB-CU shall add cell information according to the information in the Served Cell Information IE. For NG-RAN, the gNB-DU shall include the gNB-DU System Information IE.

If Served Cells To Modify Item IE is contained in the GNB-DU CONFIGURATION UPDATE message, the gNB-CU shall modify information of cell indicated by Old NR CGI IE according to the information in the Served Cell Information IE and overwrite the served cell information for the affected served cell. Further, if the gNB-DU System Information IE is present the gNB-CU shall store and replace any previous information received.

If Served Cells To Delete Item IE is contained in the GNB-DU CONFIGURATION UPDATE message, the gNB-CU shall delete information of cell indicated by Old NR CGI IE.

If Cells Status Item IE is contained in the GNB-DU CONFIGURATION UPDATE message, the gNB-CU shall update the information about the cells. If the Switching Off Ongoing IE is present in the Cells Status Item IE, contained in the GNB-DU CONFIGURATION UPDATE message, and the corresponding Service State IE is set to “Out-of-Service”, the gNB-CU shall ignore the Switching Off Ongoing IE.

If Cells to be Activated List Item IE is contained in the GNB-DU CONFIGURATION UPDATE ACKNOWLEDGE message, the gNB-DU shall activate the cell indicated by NR CGI IE and reconfigure the physical cell identity for cells for which the NR PCI IE is included.

If Cells to be Activated List Item IE is contained in the GNB-DU CONFIGURATION UPDATE ACKNOWLEDGE message and the indicated cells are already activated, the gNB-DU shall update the cell information received in Cells to be Activated List Item IE.

If Cells to be Activated List Item IE is included in the GNB-DU CONFIGURATION UPDATE ACKNOWLEDGE message, and the information for the cell indicated by the NR CGI IE includes the IAB Info IAB-donor-CU IE, the gNB-DU shall, if supported, apply the IAB STC Info IE therein to the indicated cell.

If Cells to be Deactivated List Item IE is contained in the GNB-DU CONFIGURATION UPDATE ACKNOWLEDGE message, the gNB-DU shall deactivate all the cells with NR CGI listed in the IE.

If Dedicated SI Delivery Needed UE List IE is contained in the GNB-DU CONFIGURATION UPDATE message, the gNB-CU should take it into account when informing the UE of the updated system information via the dedicated RRC message.

For NG-RAN, the gNB-CU shall include the gNB-CU System Information IE in the GNB-DU CONFIGURATION UPDATE ACKNOWLEDGE message. The SIB type to Be Updated List IE shall contain the full list of SIBs to be broadcast.

For NG-RAN, the gNB-DU may include the RAN Area Code IE in the GNB-DU CONFIGURATION UPDATE message. The gNB-CU shall store and replace any previously provided RAN Area Code IE by the received RAN Area Code IE.

For NG-RAN, the gNB-DU may include the Supported MBS FSA ID List IE in the Served Cell Information IE in the GNB-DU CONFIGURATION UPDATE message. The gNB-CU shall store and replace any previously provided MBS FSA ID list IE by the received MBS FSA ID list IE.

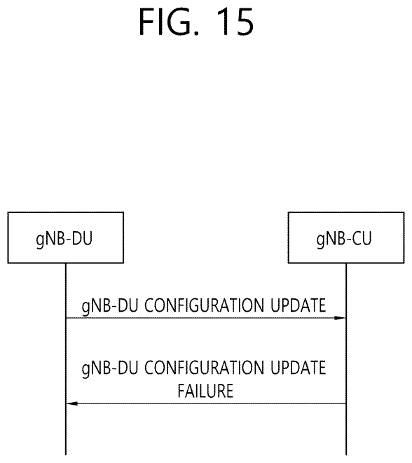

FIG. 15 shows a unsuccessful operation of a gNB-DU configuration update procedure to which implementations of the present disclosure is applied.

In FIG. 15, if the gNB-CU cannot accept the update, it shall respond with a GNB-DU CONFIGURATION UPDATE FAILURE message and appropriate cause value.

If the GNB-DU CONFIGURATION UPDATE FAILURE message includes the Time To Wait IE, the gNB-DU shall wait at least for the indicated time before reinitiating the GNB-DU CONFIGURATION UPDATE message towards the same gNB-CU.

Hereinafter, technical features related to UE Context setup are described. Section 8.3.1 of 3GPP TS 38.473 v17.1.0 may be referred.

The purpose of the UE Context Setup procedure is to establish the UE Context including, among others, SRB, DRB, BH RLC channel, Uu Relay RLC channel, PC5 Relay RLC channel, and SL DRB configuration. The procedure uses UE-associated signalling.

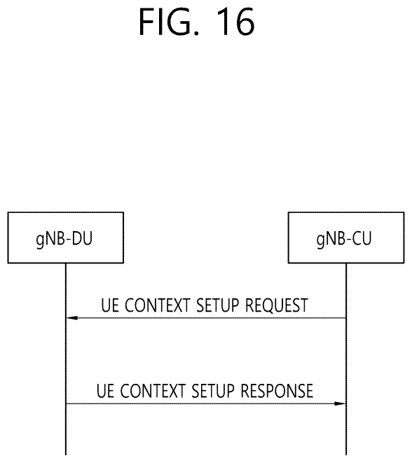

FIG. 16 shows a successful operation of a UE Context setup request procedure to which implementations of the present disclosure is applied.

In FIG. 16, the gNB-CU initiates the procedure by sending UE CONTEXT SETUP REQUEST message to the gNB-DU. If the gNB-DU succeeds to establish the UE context, it replies to the gNB-CU with UE CONTEXT SETUP RESPONSE. If no UE-associated logical F1-connection exists, the UE-associated logical F1-connection shall be established as part of the procedure. The gNB-CU shall perform RRC Reconfiguration or RRC connection resume. The CellGroupConfig IE shall transparently be signaled to the UE.

If the UE-CapabilityRAT-ContainerList IE is included in the UE CONTEXT SETUP REQUEST, the gNB-DU shall take this information into account for UE specific configurations.

If the servingCellMO IE is included in the UE CONTEXT SETUP REQUEST message, the gNB-DU shall configure servingCellMO for the indicated SpCell accordingly.

If the SpCell UL Configured IE is included in the UE CONTEXT SETUP REQUEST message, the gNB-DU shall configure UL for the indicated SpCell accordingly.

If the SCell To Be Setup List IE is included in the UE CONTEXT SETUP REQUEST message, the gNB-DU shall consider it as a list of candidate SCells to be set up. If the SCell UL Configured IE is included in the UE CONTEXT SETUP REQUEST message, the gNB-DU shall configure UL for the indicated SCell accordingly. If the servingCellMO IE is included in the UE CONTEXT SETUP REQUEST message, the gNB-DU shall configure servingCellMO for the indicated SCell accordingly.

If the DRX Cycle IE is contained in the UE CONTEXT SETUP REQUEST message, the gNB-DU shall use the provided value from the gNB-CU.

If the UL Configuration IE in DRB to Be Setup Item IE is contained in the UE CONTEXT SETUP REQUEST message, the gNB-DU shall take it into account for UL scheduling.

If the BH Information IE is included in the UL UP TNL Information to be setup List IE or the Additional PDCP Duplication TNL List IE for a DRB, the gNB-DU shall, if supported, use the indicated BAP Routing ID and BH RLC channel for transmission of the corresponding GTP-U packets to the IAB-donor.

If the BH RLC Channel To Be Setup List IE is included in the UE CONTEXT SETUP REQUEST message, the gNB-DU shall act. If the Traffic Mapping Information IE is included in the BH RLC Channel To Be Setup Item IEs IE for a BH RLC Channel, the gNB-DU shall, if supported, process the Traffic Mapping Information IE as follows:
if the IP to layer2 Traffic Mapping Info IE is included, the gNB-DU shall store the mapping information contained in the IP to layer2 Traffic Mapping Info To Add IE, if present, for the egress BH RLC channel identified by the BH RLC CH ID IE, and shall remove the previously stored mapping information as indicated by the IP to layer2 Mapping Traffic Info To Remove IE, if present. The gNB-DU shall use the mapping information stored for the mapping of IP traffic to layer2.
if the BAP layer BH RLC channel Mapping Info IE is included, the gNB-DU shall store the mapping information contained in the BAP layer BH RLC channel Mapping Info To Add IE, if present, for the egress or ingress BH RLC channel identified by the BH RLC CH ID IE, and shall remove the previously stored mapping information as indicated by the BAP layer BH RLC channel Mapping Info To Remove IE, if present. The gNB-DU shall use the mapping information stored when forwarding traffic on BAP sublayer.

The gNB-DU shall report to the gNB-CU, in the UE CONTEXT SETUP RESPONSE message, the result for all the requested DRBs, SRBs, BH RLC channels, Uu RLC channels, PC5 Relay RLC channels, and SL DRBs in the following way:
A list of DRBs which are successfully established shall be included in the DRB Setup List IE;
A list of DRBs which failed to be established shall be included in the DRB Failed to Setup List IE;
A list of SRBs which failed to be established shall be included in the SRB Failed to Setup List IE.
A list of successfully established SRBs with logical channel identities for primary path shall be included in the SRB Setup List IE only if CA based PDCP duplication is initiated for the concerned SRBs.
A list of BH RLC channels which are successfully established shall be included in the BH RLC Channel Setup List IE;
A list of BH RLC channels which failed to be established shall be included in the BH RLC Channel Failed to be Setup List IE;
A list of SL DRBs which are successfully established shall be included in the SL DRB Setup List IE;
A list of SL DRBs which failed to be established shall be included in the SL DRB Failed to Setup List IE.
A list of Uu Relay RLC channels which are successfully established shall be included in the Uu RLC Channel Setup List IE;
A list of Uu Relay RLC channels which failed to be established shall be included in the Uu RLC Channel Failed to be Setup List IE;
A list of PC5 Relay RLC channels which are successfully established shall be included in the PC5 RLC Channel Setup List IE;
A list of PC5 Relay RLC channels which failed to be established shall be included in the PC5 RLC Channel Failed to be Setup List IE;

When the gNB-DU reports the unsuccessful establishment of a DRB or SRB or SL DRB or a BH RLC channel or a Uu RLC channel or a PC5 Relay RLC channel, the cause value should be precise enough to enable the gNB-CU to know the reason for the unsuccessful establishment.

If the HandoverPreparationInformation IE is included in the CU to DU RRC Information IE in the UE CONTEXT SETUP REQUEST message, the gNB-DU of the gNB acting as master node shall regard it as a reconfiguration with sync. The gNB-CU shall only initiate the UE Context Setup procedure for handover or secondary node addition when at least one DRB is setup for the UE, or at least one BH RLC channel is set up for IAB-MT. If the HandoverPreparationInformation IE containing the sidelink related UE information is included in the UE CONTEXT SETUP REQUEST message, the gNB-DU shall regard it as an indication of V2X sidelink information.

If the BAP Control PDU Channel IE is included in the BH RLC Channel to be Setup List IE, the gNB-DU shall, if supported, consider that the configured BH RLC channel can be used to transmit BAP Control PDUs, and use this BH RLC channel.

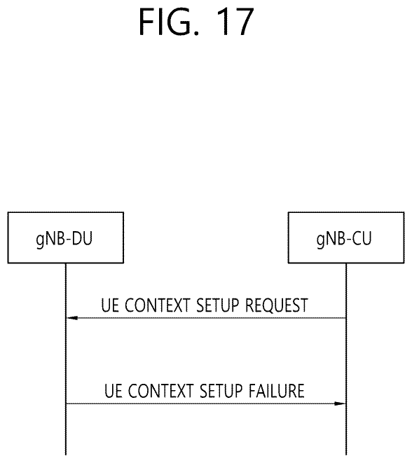

FIG. 17 shows an unsuccessful operation of a UE Context setup request procedure to which implementations of the present disclosure is applied.

In FIG. 17, if the gNB-DU is not able to establish an F1 UE context, or cannot even establish one bearer it shall consider the procedure as failed and reply with the UE CONTEXT SETUP FAILURE message. If the Conditional Inter-DU Mobility Information IE was included in the UE CONTEXT SETUP REQUEST message, the gNB-DU shall include the received SpCell ID IE as the Requested Target Cell ID IE in the UE CONTEXT SETUP FAILURE message.

If the gNB-DU is not able to accept the SpCell ID IE in UE CONTEXT SETUP REQUEST message, it shall reply with the UE CONTEXT SETUP FAILURE message with an appropriate cause value. Further, if the Candidate SpCell List IE is included in the UE CONTEXT SETUP REQUEST message and the gNB-DU is not able to accept the SpCell ID IE, the gNB-DU shall, if supported, include the Potential SpCell List IE in the UE CONTEXT SETUP FAILURE message and the gNB-CU should take this into account for selection of an opportune SpCell. The gNB-DU shall include the cells in the Potential SpCell List IE in a priority order, where the first cell in the list is the one most desired and the last one is the one least desired (e.g., based on load conditions). If the Potential SpCell List IE is present but no Potential SpCell Item IE is present, the gNB-CU should assume that none of the cells in the Candidate SpCell List IE are acceptable for the gNB-DU.

Hereinafter, technical features related to DL RRC message transfer are described. Section 8.4.2 of 3GPP TS 38.473 v17.1.0 may be referred.

The purpose of the DL RRC Message Transfer procedure is to transfer an RRC message. The procedure uses UE-associated signalling.

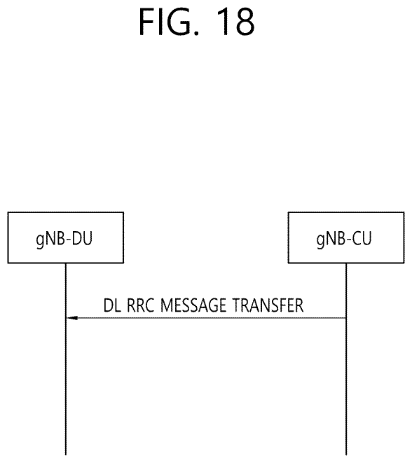

FIG. 18 shows a DL RRC Message Transfer procedure to which implementations of the present disclosure is applied.

In FIG. 18, the gNB-CU initiates the procedure by sending a DL RRC MESSAGE TRANSFER message. If a UE-associated logical F1-connection exists, the DL RRC MESSAGE TRANSFER message shall contain the gNB-DU UE F1AP ID IE, which should be used by gNB-DU to lookup the stored UE context. If no UE-associated logical F1-connection exists, the UE-associated logical F1-connection shall be established at reception of the DL RRC MESSAGE TRANSFER message.

If the Index to RAT Frequency Selection Priority IE is included in the DL RRC MESSAGE TRANSFER, the gNB-DU may use it for RRM purposes. If the Additional RRM Policy Index IE is included in the DL RRC MESSAGE TRANSFER, the gNB-DU may use it for RRM purposes.

The DL RRC MESSAGE TRANSFER message shall include, if available, the old gNB-DU UE F1AP ID IE so that the gNB-DU can retrieve the existing UE context in RRC connection reestablishment procedure.

The DL RRC MESSAGE TRANSFER message shall include, if SRB duplication is activated, the Execute Duplication IE, so that the gNB-DU can perform CA based duplication for the SRB.

If the gNB-DU identifies the UE-associated logical F1-connection by the gNB-DU UE F1AP ID IE in the DL RRC MESSAGE TRANSFER message and the old gNB-DU UE F1AP ID IE is included, it shall release the old gNB-DU UE F1AP ID and the related configurations associated with the old gNB-DU UE F1AP ID.

If the UE Context not retrievable IE set to “true” is included in the DL RRC MESSAGE TRANSFER, the DL RRC MESSAGE TRANSFER may contain the Redirected RRC message IE and use it.

If the UE Context not retrievable IE set to “true” is included in the DL RRC MESSAGE TRANSFER, the DL RRC MESSAGE TRANSFER may contain the PLMN Assistance Info for Network Sharing IE, if available at the gNB-CU and may use it.

If the DL RRC MESSAGE TRANSFER message contains the New gNB-CU UE F1AP ID IE, the gNB-DU shall, if supported, replace the value received in the gNB-CU UE F1AP ID IE by the value of the New gNB-CU UE F1AP ID and use it for further signalling.

Interactions with UE Context Release Request procedure:

If the UE Context not retrievable IE set to “true” is included in the DL RRC MESSAGE TRANSFER, the gNB-DU may trigger the UE Context Release Request procedure.

Meanwhile, in NR, there is an effort to reflect the mobile IAB-node scenario supporting the Uncrewed Aerial Vehicle (UAV) feature to the Mobile IAB for NR WI.

The support for Mobile Integrated Access and Backhaul (IAB) builds on the architecture and protocols derived in the Rel-17 WI NR_IAB_enh, which provided IAB improvements on various aspects such as robustness, load-balancing, spectral efficiency, and end-to-end performance.

The work on Mobile IAB in Rel-18 should focus on the scenario of mobile-IAB-nodes mounted on vehicles providing 5G coverage/capacity enhancement to onboard and/or surrounding UEs.

In Rel-18, mobile IAB supports the following functionality, applicable to FR1 and FR2:
In-band and out-of-band backhauling.
The mobile IAB-node should have no descendent IAB-nodes, i.e., it serves only UEs.
Solutions should support UE HO and DC.
The MT of a mobile IAB-node should support UAV features for UAM services.

The detailed objectives of the WI are listed as follows:
Define Procedures for migration/topology adaptation to enable IAB-node mobility, including inter-donor migration of the entire mobile IAB-node (full migration)
Enhancements for mobility of an IAB-node together with its served UEs, including aspects related to group mobility. No optimizations for the targeting of surrounding UEs.
Mitigation of interference due to IAB-node mobility, including the avoidance of potential reference and control signal collisions (e.g. PCI, RACH).
The MT of IAB-node equipped with UAB features
As for UAM use case, define procedures for the DU of IAB-node to provide flying state information of a UE riding the aerial vehicle

Considering the mobile IAB-node supporting the Uncrewed Aerial Vehicle (UAV) feature, while the mobile IAB-node is in flight, the wireless devices receiving services through the mobile IAB-node are affected by interference from more base stations than when they are on the ground. Therefore, the downlink and uplink throughput of the wireless devices are degraded.

In addition, since the wireless devices receiving service through the mobile IAB-node cannot perform altitude-based measurements, there is no way to inform the base station that they are in flight.

In addition, the wireless devices receiving service through the mobile IAB-node can measure a cell with a temporarily strong signal during flight. If the measurement results are reported to the base station, the base station can perform Autonomous Neighbor Relationship (ANR) based on this. As a result, the base station can have an invalid Neighbor Relationship Table (NRT).

Therefore, a method for improving the downlink and uplink throughput of a wireless device belonging to a mobile IAB-node having a UAV feature is required. In addition, a method is needed to prevent a base station from having erroneous NRT by not performing measurements during flight.

That is, studies for supporting aerial mobility in mobile IAB networks are required.

Hereinafter, a method for supporting aerial mobility in mobile IAB networks, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

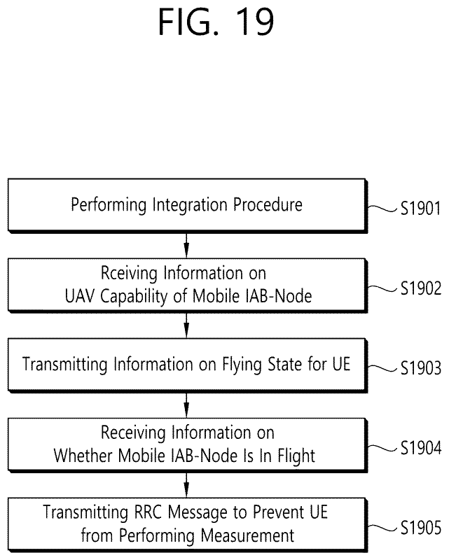

FIG. 19 shows an example of a method for supporting aerial mobility in mobile IAB networks, according to some embodiments of the present disclosure.

For example, an IAB-donor may include an IAB-donor-central unit (CU) and an IAB-donor-distributed unit (DU). A mobile IAB-node may include a mobile IAB-node-MT (i.e., an MT function) and a mobile IAB-node-DU (i.e., a DU function).

In particular, FIG. 19 shows an example of a method performed by an IAB-donor-central unit (CU).

In step S1901, an IAB-donor-CU may perform an integration procedure with a mobile IAB-node.

For example, the IAB-donor-CU may initiate an integration procedure with a mobile IAB-node. The IAB-donor-CU may perform an IAB-MT setup procedure with the mobile IAB-node. The IAB-donor-CU may perform a backhaul radio link control (BH RLC) channel establishment with the mobile IAB-node. The IAB-donor-CU may perform a routing update with the mobile IAB-node. The IAB-donor-CU may perform an IAB-Distributed Unit (DU) setup procedure with the mobile IAB-node.

In step S1902, the IAB-donor-CU may receive, from the mobile IAB-node, information on an Unmanned Aerial Vehicle (UAV) Capability of the mobile IAB-node. For example, the IAB-donor-CU may receive, from the mobile IAB-node, information on the UAV Capability of the mobile IAB-node during in the integration procedure.

For example, the information on the UAV Capability of the mobile IAB-node may be transmitted from a DU of the mobile IAB-node by being included in an F1 message. For example, the F1 message may be an F1 Setup Request message.

For example, the information on the UAV Capability of the mobile IAB-node may be transmitted from a mobile termination (MT) of the mobile IAB-node by being included in an RRC message.

For example, the IAB-donor-CU may generate information on a flying state for a UE which belongs to the mobile IAB-node (for example, a flying state information element (IE) or a new IE), upon receiving the UAV capability of the mobile IAB-node.

Then, the IAB-donor-CU may include the information on the flying state (for example, a flying state IE or a new IE) in a message to the mobile IAB-node (for example, a UE Context Setup Request message, and/or a gNB-DU Configuration Update Acknowledge message, and/or a DL RRC Message Transfer message, and/or a new message).

For example, information on a flying state (for example, a flying state IE or a new IE) may be configured per UE. Alternatively, information on a flying state (for example, a flying state IE or a new IE) may be configured per group of UEs which belong to a certain mobile IAB-node.

According to some embodiments of the present disclosure, a wireless device may perform a handover from the gNB to the corresponding mobile IAB-node. In this case, the IAB-donor-CU may generate information on the flying state of the wireless device. The IAB-donor-CU may provide the information on the flying state of the wireless device to the mobile IAB-node. Alternatively, the wireless device may perform initial access rather than handover to the mobile IAB-node. In this case, the mobile IAB-node may generate the information on the flying state of the wireless device. Also, the mobile IAB-node may provide the information on the flying state of the wireless device to the IAB-donor-CU.

In step S1903, the IAB-donor-CU may transmit, to the mobile IAB-node, information on a flying state for a UE.

When the mobile IAB-node receives the message including the information on the flying state for the UE, the mobile IAB-node may generate or configure the information on the flying state (for example, a flying state IE or a new IE) for the UE.

Then, the mobile IAB-node may include the information on the flying state in a message to the IAB-donor (for example, an IAB-donor-CU and/or an IAB-donor-DU) (for example, a UE Context Setup Response message, and/or a gNB-DU Configuration Update message, and/or a new message).

For example, in step S1903, the IAB-donor-CU may transmit, to the mobile IAB-node, a UE Context Setup Request message including the information on a flying state for a UE.

For example, the IAB-donor-CU may receive, from the mobile IAB-node, a UE Context Setup Response message including information on the flying state for the UE.

In step S1904, the IAB-donor-CU may receive, from the mobile IAB-node, information on whether the mobile IAB-node is in flight.

For example, the IAB-donor-CU may receive, from the mobile IAB-node, a gNB-DU Configuration Update message including information on whether the mobile IAB-node is in flight, based on that the mobile IAB-node starts flight. In this case, for example, the IAB-donor-CU could change the information on the flying state for a UE (that is, all UEs belong to the mobile IAB-node) from ‘not in flight’ to ‘in flight’. For example, the IAB-donor-CU may change the flying state IE for the UE from ‘not in flight (for example, a first value)’ to ‘in flight (for example, a second value)’.

For example, the IAB-donor-CU may transmit, to the mobile IAB-node, a gNB-DU Configuration Update Acknowledgement message. For example, a gNB-DU Configuration Update Acknowledgement message may include the information on the flying state. For example, the IAB-donor-CU may include the changed information on the flying state (for example, the changed flying state IE) in the gNB-DU Configuration Update Acknowledgement message.

In step S1905, the IAB-donor-CU may transmit, to the UE, an RRC message to prevent the UE from performing measurements.

For example, the IAB-donor-CU may transmit, to the UE through the mobile IAB-node, (i) an RRC message including a measurement stop indication, and/or (2) an RRC message without information related to measurements.

For example, the RRC message including a measurement stop indication may be an RRC reconfiguration message. For example, the RRC message without information related to measurements may be an RRC reconfiguration message.

For example, the IAB-donor-CU may transmit, to the mobile IAB-node, a Downlink (DL) RRC Message Transfer message including the RRC message (for example, the RRC reconfiguration message). That is, the RRC message may be included in the DL RRC message transfer.

According to some embodiments of the present disclosure, the IAB-donor-CU may receive, from the mobile IAB-node, a moving indication informing that the mobile IAB-node starts flight. Upon receiving the moving indication, the IAB-donor-CU may configure the flying state for a UE that belongs to the mobile IAB-node as ‘flight’ (or other value meaning that the UE is in flight). For example, the moving indication may be included in the gNB-DU Configuration Update message.

Alternatively, for example, the IAB-donor-CU may consider the information on the flying state for a UE which belongs to the mobile IAB-node (for example, a flying state IE for a UE) as the moving indication for the mobile IAB-node. When the information on the flying state informs that a UE which belongs to a mobile IAB-node (for example, a flying state IE for a UE) is in flight, the IAB-donor-CU may consider that the mobile IAB-node is in flight.

According to some embodiments of the present disclosure, the IAB-donor-CU may determine that the mobile IAB-node is in flight based on measurements report provided by the mobile IAB-node. For example, the measurements report may include information on altitude of the mobile IAB-node.

According to some embodiments of the present disclosure, the UE may be in communication with at least one of a user equipment, a network, or an autonomous vehicle other than the wireless device.

Hereinafter, an embodiment of a method for supporting aerial mobility in mobile IAB networks will be described.

A mobile IAB-node with UAV capability can perform integration into IAB-donor-CU. In addition, a UE can perform a handover from the gNB to the corresponding mobile IAB-node.

In this case, the IAB-donor-CU may generate flying state-related information for the handover UE based on the UAV capability information of the mobile IAB-node. In addition, the IAB-donor-CU may provide information related to the generated flying state to the mobile IAB-node.

Alternatively, the UE may perform initial access rather than handover to the mobile IAB-node. In this case, the mobile IAB-node can generate flying state-related information. Also, the mobile IAB-node may provide flying state-related information to the IAB-donor-CU.

For example, the mobile IAB-node with the UAV capability can perform integration into IAB-donor-CU. Through an RRC message from the mobile IAB-node-MT or an F1 message from the mobile IAB-node-DU, the mobile IAB-node may provide a UAV Capability Indication to the IAB-donor-CU. Therefore, the IAB-donor-CU may know that the integrated mobile IAB-node has UAV capability.

When the mobile IAB-node with UAV capability starts to fly, the IAB-donor-CU can prevent UEs belonging to (boarding) the mobile IAB-node from performing measurements on cells (until they get off the mobile IAB-node).

For this, the IAB-donor-CU may transmit an RRC message including a Measurement Stop Indication to the UE or provide an RRC message with measurement-related information removed.

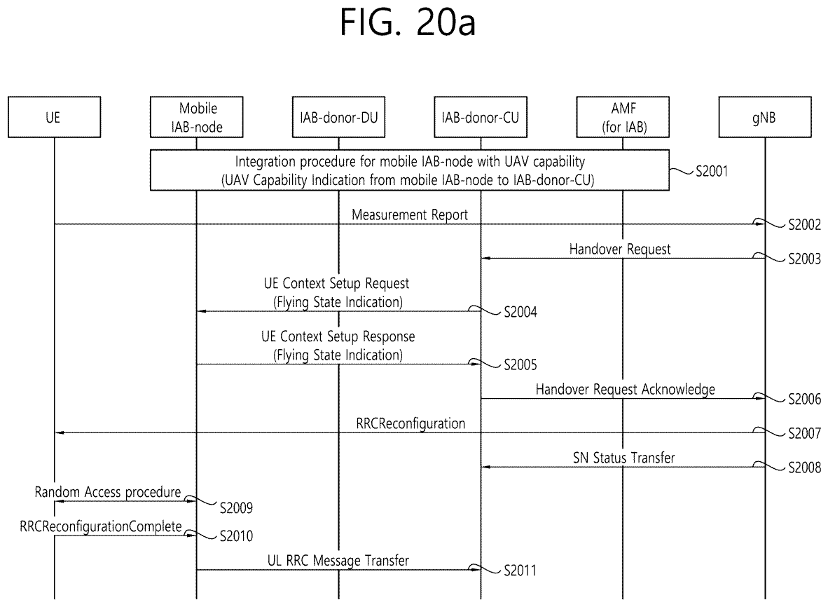

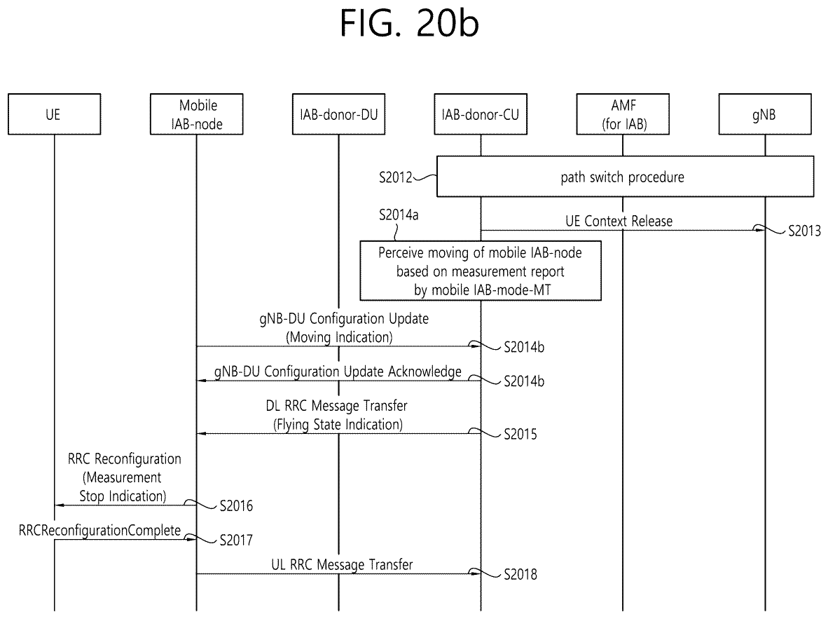

FIGS. 20a and 20b show an example of an Xn Handover procedure toward a mobile IAB-node with UAV capability and a procedure when the mobile IAB-node with UAV capability begins to fly.

In particular, FIGS. 20a and 20b suggest a method of preventing a UE belonging to a mobile IAB-node from performing measurements on cells.

For example, when the UE belonging to the gNB or the IAB-node performs handover to the mobile IAB-node having UAV capability and the mobile IAB-node starts flight, the UE belonging to the mobile IAB-node may not perform measurement of cells until the UE belonging to the mobile IAB-node gets off the mobile IAB-node.

In step S2001, the mobile IAB-node with UAV capability may perform an integration procedure with the IAB-donor-CU.

In the integration procedure, the mobile IAB-node may inform that it has UAV capability. For this, the mobile IAB-node may provide a UAV Capability Indication to the IAB-donor-CU, through (i) an RRC message from mobile IAB-node-MT or (ii) an existing F1 Setup Request message, another F1 message, or a new F1 message from the mobile IAB-node-DU. Upon receiving the UAV Capability Indication, the IAB-donor-CU may know (or recognize) that the corresponding mobile IAB-node has UAV capability.

In step S2002, the UE may report to the gNB according to the measurement configuration of the gNB.

In step S2003, the gNB may determine the handover of the UE based on the received measurement report and RRM information. To request handover, the gNB may send a Handover Request message to the IAB-donor-CU.

In step S2004, upon receiving the Handover Request message, the IAB-donor-CU may know that the target node for the handover is a mobile IAB-node with UAV capability. Based on this, the IAB-donor-CU can configure and store the Flying State for the corresponding UE. Here, Flying State indicates whether a corresponding UE belonging to the mobile IAB-node is in flight.

To create a context for the UE, the IAB-donor-CU may transmit a UE Context Setup Request message to the mobile IAB-node. In order to notify the mobile IAB-node of Flying State-related information configured by IAB-donor-CU, this message may include Flying State Indication.

In step S2005, if the Flying State Indication is included in the received UE Context Setup Request message, the mobile IAB-node may store the Flying State.

In response to the Request message, the Mobile IAB-node may transmit a UE Context Setup Response message to the IAB-donor-CU.

If the UE performs initial access rather than handover to the mobile IAB-node, when the UE Context Setup Request message is received from IAB-donor-CU, the mobile IAB-node can configure and store the Flying State for the UE. In addition, in order to inform IAB-donor-CU of Flying State-related information configured by mobile IAB-node, Flying State Indication may be included in the UE Context Setup Response message.

In step S2006, if the Flying State Indication is included in the Response message received from the mobile IAB-node, the IAB-donor-CU may store the Flying State. Upon receiving the UE Context Setup Response message, the IAB-donor-CU may transmit the Handover Request Acknowledge message to gNB.

In step S2007, the gNB may transmit an RRCReconfiguration message to the UE.

In step S2008, in order to inform PDCP Sequence Number status, the gNB may send SN Status Transfer message to the IAB-donor-CU.

In step S2009, the UE may disconnect from the gNB. The UE may perform a random access procedure to establish a connection with the mobile IAB-node.

In step S2010, the UE may send an RRCReconfigurationComplete message to the mobile IAB-node.

In step S2011, upon receiving the RRCReconfigurationComplete message from the UE, the mobile IAB-node may use the UL RRC Message Transfer message to transfer the received RRC message to the IAB-donor-CU.

In step S2012, upon receiving the RRC message, the IAB-donor-CU may perform the Path Switch procedure with a CN.

In step S2013, upon completion of the Path Switch procedure, the IAB-donor-CU may transmit a UE Context Release message to the gNB.

Depending on how the IAB-donor-CU recognizes that the mobile IAB-node is starting to fly, one of the following two methods can be used:

In step S2014-a, based on the measurement report provided by mobile IAB-node-MT (e.g. change in altitude), the IAB-donor-CU may know that mobile IAB-node has started the flight. At this time, the IAB-donor-CU may change and store the Flying State value of the UE belonging to the mobile IAB-node.

In step S2014-b, in order to notify that the mobile IAB-node has started flying, the mobile IAB-node may transmit a gNB-DU Configuration Update message, another F1 message, or a new F1 message with a Moving Indication to the IAB-donor-CU. Upon receiving the message from the mobile IAB-node, the IAB-donor-CU can transmit a gNB-DU Configuration Update Acknowledge message to the mobile IAB-node in response. In addition, the IAB-donor-CU may change and store the Flying State value of the UE belonging to the mobile IAB-node.

In step S2015, upon recognizing that the mobile IAB-node has started flight, in order to prevent the UE from performing measurements on cells, the IAB-donor-CU may (i) include the Measurement Stop Indication in the RRCReconfiguration message or (ii) remove measurement-related information from the RRCReconfiguration message. IAB-donor-CU can transmit the RRCReconfiguration message to the mobile IAB-node by being included in the DL RRC Message Transfer message.

For example, the RRCReconfiguration message may include a Flying State Indication, and may inform the mobile IAB-node that the Flying State of a UE belonging to itself has changed.

In step S2016, the mobile IAB-node can transmit the RRCReconfiguration message carried in the DL RRC Message Transfer message to the UE. If the Flying State Indication is included in the received Transfer message, the mobile IAB-node may store the Flying State.

In step S2017, upon receiving the RRCReconfiguration message, the UE may not perform measurements for the cells based on the Measurement Stop Indication included in the message. Otherwise, the UE may not perform measurements for the cells since there is no measurement-related information (for example, measurements configuration) in the message.

In response to the received RRCReconfiguration message, the UE may transmit an RRCReconfigurationComplete message to the mobile IAB-node.

In step S2018, upon receiving the RRCReconfigurationComplete message, the mobile IAB-node may transfer the received RRC message to the UL RRC Message Transfer message to the IAB-donor-CU.

According to some embodiments of the present disclosure, a method for preventing a UE belonging to a mobile IAB-node in flight from performing measurements on cells may be proposed.

For example, the UE may perform a handover to a mobile IAB-node having UAV capability. When the corresponding mobile IAB-node starts flying, it is possible not to perform measurements for cells until the UE belonging to the mobile IAB-node gets off the mobile IAB-node.

For example, the mobile IAB-node can integrate with the IAB-donor-CU. At this time, the mobile IAB-node may inform the IAB-donor-CU that it has a UAV feature. For example, the IAB-donor-CU may receive a UAV Capability Indication from the mobile IAB-node.

For example, the UAV Capability Indication may be received through an RRC message sent by the mobile IAB-node-MT.

For example, the UAV Capability Indication can be received through the F1 message sent by the mobile IAB-node-DU.

For example, upon receiving a Handover Request message for the handover of a UE, the IAB-donor-CU may configure and store a Flying State for the corresponding UE. Thereafter, the IAB-donor-CU may provide, to the mobile IAB-node, a Flying State Indication for notifying Flying state-related information of the corresponding UE.

Upon recognizing that the mobile IAB-node has started flight, the IAB-donor-CU can change the Flying State of the UE belonging to the mobile IAB-node. The IAB-donor-CU may provide Flying State Indication to notify the mobile IAB-node of the changed Flying State. The IAB-donor-CU may provide an RRC message to prevent the UE from performing measurements.

For example, the RRC message may include Measurement Stop Indication. Alternatively, measurements-related information may be removed from the provided RRC message.

For example, in order for the IAB-donor-CU to recognize that the mobile IAB-node has started flight, the IAB-donor-CU may receive a moving indication from the mobile IAB-node.

Some of the detailed steps shown in the examples of FIGS. 19 to 20 may not be essential steps and may be omitted. In addition to the steps shown in FIGS. 19 to 20, other steps may be added, and the order of the steps may vary. Some of the above steps may have their own technical meaning.

Hereinafter, an apparatus for supporting aerial mobility in mobile IAB networks, according to some embodiments of the present disclosure, will be described. Herein, the apparatus may be an IAB-donor and a mobile IAB-node may be the IAB-donor and the IAB-node in FIGS. 9 and 10.

For example, an IAB-donor may include an IAB-donor-central unit (CU) and an IAB-donor-distributed unit (DU). A mobile IAB-node may include a mobile IAB-node-MT (i.e., an MT function) and a mobile IAB-node-DU (i.e., a DU function).

For example, an IAB-donor-CU may perform the methods described above. The detailed description overlapping with the above-described contents could be simplified or omitted.

According to some embodiments of the present disclosure, an IAB-donor-CU may comprise a memory; and at least one processor operatively coupled to the memory.

The at least one processor may be configured to initiate an integration procedure with a mobile IAB-node. The at least one processor may be configured to perform an IAB-MT setup procedure with the mobile IAB-node. The at least one processor may be configured to perform a backhaul radio link control (BH RLC) channel establishment with the mobile IAB-node. The at least one processor may be configured to perform a routing update with the mobile IAB-node. The at least one processor may be configured to perform an IAB-Distributed Unit (DU) setup procedure with the mobile IAB-node. The at least one processor may be configured to receive, from the mobile IAB-node, information on an Unmanned Aerial Vehicle (UAV) Capability of the mobile IAB-node, in the integration procedure. The at least one processor may be configured to transmit, to the mobile IAB-node, a UE Context Setup Request including information on a flying state for a UE. The at least one processor may be configured to receive, from the mobile IAB-node, a gNB-DU configuration update message including information on whether the mobile IAB-node is in flight. The at least one processor may be configured to transmit, to the UE through the mobile IAB-node, (i) an RRC message including a measurement stop indication, and/or (2) an RRC message without information related to measurements.

For example, the at least one processor may be configured to receive, from the mobile IAB-node, a UE context setup response including information on the flying state for the UE.

For example, the at least one processor may be configured to transmit, to the mobile IAB-node, a gNB-DU configuration update acknowledgement.

For example, (i) the RRC message including a measurement stop indication, and/or (2) the RRC message without information related to measurements may be an RRC reconfiguration message.

For example, the at least one processor may be configured to transmit, to the mobile IAB-node, a downlink (DL) RRC Message Transfer including the RRC reconfiguration message.

For example, the information on the UAV Capability of the mobile IAB-node may be transmitted from a DU of the mobile IAB-node by being included in an F1 message. The F1 message may include an F1 Setup Request message.

For example, the information on the UAV Capability of the mobile IAB-node may be transmitted from a mobile termination (MT) of the mobile IAB-node by being included in an RRC message.

For example, the at least one processor may be configured to determine the flying state of the mobile IAB-node based on measurements report provided by the mobile IAB-node. For example, the measurements report may include information on altitude of the mobile IAB-node.

For example, the at least one processor may be configured to receive, from the mobile IAB-node, a moving indication informing that the mobile IAB-node starts flight.

For example, the moving indication may be included in the gNB-DU configuration update message.

For example, the at least one processor may be further configured to be in communication with at least one of a user equipment, a network, or an autonomous vehicle other than the wireless device.

Hereinafter, a processor for an IAB-donor-CU for supporting aerial mobility in mobile IAB networks, according to some embodiments of the present disclosure, will be described.

The processor may be configured to control the IAB-donor-CU to initiate an integration procedure with a mobile IAB-node. The processor may be configured to control the IAB-donor-CU to perform an IAB-MT setup procedure with the mobile IAB-node. The processor may be configured to control the IAB-donor-CU to perform a backhaul radio link control (BH RLC) channel establishment with the mobile IAB-node. The processor may be configured to control the IAB-donor-CU to perform a routing update with the mobile IAB-node. The processor may be configured to control the IAB-donor-CU to perform an IAB-Distributed Unit (DU) setup procedure with the mobile IAB-node. The processor may be configured to control the IAB-donor-CU to receive, from the mobile IAB-node, information on an Unmanned Aerial Vehicle (UAV) Capability of the mobile IAB-node, in the integration procedure. The processor may be configured to control the IAB-donor-CU to transmit, to the mobile IAB-node, a UE Context Setup Request including information on a flying state for a UE. The processor may be configured to control the IAB-donor-CU to receive, from the mobile IAB-node, a gNB-DU configuration update message including information on whether the mobile IAB-node is in flight. The processor may be configured to control the IAB-donor-CU to transmit, to the UE through the mobile IAB-node, (i) an RRC message including a measurement stop indication, and/or (2) an RRC message without information related to measurements.

For example, the processor may be configured to control the IAB-donor-CU to receive, from the mobile IAB-node, a UE context setup response including information on the flying state for the UE.

For example, the processor may be configured to control the IAB-donor-CU to transmit, to the mobile IAB-node, a gNB-DU configuration update acknowledgement.

For example, (i) the RRC message including a measurement stop indication, and/or (2) the RRC message without information related to measurements may be an RRC reconfiguration message.

For example, the processor may be configured to control the IAB-donor-CU to transmit, to the mobile IAB-node, a downlink (DL) RRC Message Transfer including the RRC reconfiguration message.

For example, the information on the UAV Capability of the mobile IAB-node may be transmitted from a DU of the mobile IAB-node by being included in an F1 message. The F1 message may include an F1 Setup Request message.

For example, the information on the UAV Capability of the mobile IAB-node may be transmitted from a mobile termination (MT) of the mobile IAB-node by being included in an RRC message.

For example, the processor may be configured to control the IAB-donor-CU to determine the flying state of the mobile IAB-node based on measurements report provided by the mobile IAB-node. For example, the measurements report may include information on altitude of the mobile IAB-node.

For example, the processor may be configured to control the IAB-donor-CU to receive, from the mobile IAB-node, a moving indication informing that the mobile IAB-node starts flight.

For example, the moving indication may be included in the gNB-DU configuration update message.

For example, the at least one processor may be further configured to be in communication with at least one of a user equipment, a network, or an autonomous vehicle other than the wireless device.

Hereinafter, a non-transitory computer-readable medium has stored thereon a plurality of instructions for supporting aerial mobility in mobile IAB networks, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of an IAB-donor-CU.

The stored a plurality of instructions may cause the IAB-donor-CU to initiate an integration procedure with a mobile IAB-node. The stored a plurality of instructions may cause the IAB-donor-CU to perform an IAB-MT setup procedure with the mobile IAB-node. The stored a plurality of instructions may cause the IAB-donor-CU to perform a backhaul radio link control (BH RLC) channel establishment with the mobile IAB-node. The stored a plurality of instructions may cause the IAB-donor-CU to perform a routing update with the mobile IAB-node. The stored a plurality of instructions may cause the IAB-donor-CU to perform an IAB-Distributed Unit (DU) setup procedure with the mobile IAB-node. The stored a plurality of instructions may cause the IAB-donor-CU to receive, from the mobile IAB-node, information on an Unmanned Aerial Vehicle (UAV) Capability of the mobile IAB-node, in the integration procedure. The stored a plurality of instructions may cause the IAB-donor-CU to transmit, to the mobile IAB-node, a UE Context Setup Request including information on a flying state for a UE. The stored a plurality of instructions may cause the IAB-donor-CU to receive, from the mobile IAB-node, a gNB-DU configuration update message including information on whether the mobile IAB-node is in flight. The stored a plurality of instructions may cause the IAB-donor-CU to transmit, to the UE through the mobile IAB-node, (i) an RRC message including a measurement stop indication, and/or (2) an RRC message without information related to measurements.

For example, the stored a plurality of instructions may cause the IAB-donor-CU to receive, from the mobile IAB-node, a UE context setup response including information on the flying state for the UE.

For example, the stored a plurality of instructions may cause the IAB-donor-CU to transmit, to the mobile IAB-node, a gNB-DU configuration update acknowledgement.

For example, (i) the RRC message including a measurement stop indication, and/or (2) the RRC message without information related to measurements may be an RRC reconfiguration message.

For example, the stored a plurality of instructions may cause the IAB-donor-CU to transmit, to the mobile IAB-node, a downlink (DL) RRC Message Transfer including the RRC reconfiguration message.

For example, the information on the UAV Capability of the mobile IAB-node may be transmitted from a DU of the mobile IAB-node by being included in an F1 message. The F1 message may include an F1 Setup Request message.

For example, the information on the UAV Capability of the mobile IAB-node may be transmitted from a mobile termination (MT) of the mobile IAB-node by being included in an RRC message.

For example, the stored a plurality of instructions may cause the IAB-donor-CU to determine the flying state of the mobile IAB-node based on measurements report provided by the mobile IAB-node. For example, the measurements report may include information on altitude of the mobile IAB-node.

For example, the stored a plurality of instructions may cause the IAB-donor-CU to receive, from the mobile IAB-node, a moving indication informing that the mobile IAB-node starts flight.

For example, the moving indication may be included in the gNB-DU configuration update message.

For example, the at least one processor may be further configured to be in communication with at least one of a user equipment, a network, or an autonomous vehicle other than the wireless device.

According to some embodiments of the present disclosure, the stored a plurality of instructions may cause the wireless device to be in communication with at least one of a user equipment, a network, or an autonomous vehicle other than the wireless device.

Hereinafter, a method performed by a wireless device for supporting aerial mobility in mobile IAB networks, according to some embodiments of the present disclosure, will be described.

The wireless device may receive, by the wireless device from an Integrated Access and Backhaul (IAB)-donor-Central Unit (CU) through a mobile IAB-node, (i) an RRC message including a measurement stop indication, and/or (2) an RRC message without information related to measurements, wherein the IAB-donor CU initiates an integration procedure with the mobile IAB-node, wherein the IAB-donor CU receives, from the mobile IAB-node, information on an Unmanned Aerial Vehicle (UAV) Capability of the mobile IAB-node, in the integration procedure, wherein the IAB-donor CU transmits, to the mobile IAB-node, a UE Context Setup Request including information on a flying state for the wireless device, and wherein the IAB-donor CU receive, from the mobile IAB-node, a gNB-DU configuration update message including information on whether the mobile IAB-node is in flight, based on the information on the flying state of the mobile IAB-node being changed, and wherein the IAB-donor CU generates (i) the RRC message including the measurement stop indication, and/or (2) the RRC message without the information related to measurements.

Hereinafter, wireless device for supporting aerial mobility in mobile IAB networks, according to some embodiments of the present disclosure, will be described.

The wireless device may include a transceiver, a memory, and a processor operatively coupled to the transceiver and the memory. For example, the wireless device may be the first wireless device 100 or the second wireless device 200 of FIGS. 2 and 3, or the UE 100 of FIG. 4.

The processor may be configured to control the transceiver to receive, from an Integrated Access and Backhaul (IAB)-donor-Central Unit (CU) through a mobile IAB-node, (i) an RRC message including a measurement stop indication, and/or (2) an RRC message without information related to measurements, wherein the IAB-donor CU initiates an integration procedure with the mobile IAB-node, wherein the IAB-donor CU receives, from the mobile IAB-node, information on an Unmanned Aerial Vehicle (UAV) Capability of the mobile IAB-node, in the integration procedure, wherein the IAB-donor CU transmits, to the mobile IAB-node, a UE Context Setup Request including information on a flying state for the wireless device, and wherein the IAB-donor CU receive, from the mobile IAB-node, a gNB-DU configuration update message including information on whether the mobile IAB-node is in flight, based on the information on the flying state of the mobile IAB-node being changed, and wherein the IAB-donor CU generates (i) the RRC message including the measurement stop indication, and/or (2) the RRC message without the information related to measurements.

The present disclosure can have various advantageous effects.

According to some embodiments of the present disclosure, an Integrated Access and Backhaul (IAB) donor could efficiently support aerial mobility of a mobile IAB-node in wireless communication system.

For example, a wireless device may handover to a mobile IAB-node having UAV capability. When the mobile IAB-node starts moving, the wireless device belonging to the mobile IAB-node may not perform measurement of cells. The IAB-donor-CU or mobile IAB-node may generate a flying state for the corresponding wireless device and provide it to the mobile IAB-node or IAB-donor-CU.

When IAB-donor-CU recognizes the start of mobile IAB-node movement, the IAB-donor-CU may (1) transmit an RRC message with an indicator so that the UE does not perform measurement, or (2) transmit an RRC message with measurement-related information removed.

Through this method, the downlink and uplink throughput of the wireless device can be improved. In addition, by preventing the wireless device from performing measurement while belonging to the mobile IAB-node, it is possible to prevent base stations from having erroneous NRT.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
Initiating, by an Integrated Access and Backhaul (IAB)-donor-Central Unit (CU), an integration procedure with a mobile IAB-node;
performing, by the IAB-donor-CU, an IAB-MT setup procedure with the mobile IAB-node;
performing, by the IAB-donor-CU, a backhaul radio link control (BH RLC) channel establishment with the mobile IAB-node;
performing, by the IAB-donor-CU, a routing update with the mobile IAB-node;
performing, by the IAB-donor-CU, an IAB-Distributed Unit (DU) setup procedure with the mobile IAB-node;
receiving, by the IAB-donor-CU from the mobile IAB-node, information on an Unmanned Aerial Vehicle (UAV) Capability of the mobile IAB-node, in the integration procedure;
transmitting, by the IAB-donor-CU to the mobile IAB-node, a UE Context Setup Request message including information on a flying state for a UE;
receiving, by the IAB-donor-CU, from the mobile IAB-node, a gNB-DU Configuration Update message including information on whether the mobile IAB-node is in flight; and
transmitting, by the IAB-donor-CU, to the UE through the mobile IAB-node, (i) an RRC message including a measurement stop indication, and/or (2) an RRC message without information related to measurements.

2. The method of claim 1, wherein the method further comprises,
receiving, by the IAB-donor-CU from the mobile IAB-node, a UE Context Setup Response message including information on the flying state for the UE.

3. The method of claim 1, wherein the method further comprises,
transmitting, by the IAB-donor-CU to the mobile IAB-node, a gNB-DU Configuration Update Acknowledgement message.

4. The method of claim 1,
wherein the RRC message is an RRC reconfiguration message.

5. The method of claim 4, wherein the method further comprises,
transmitting, by the IAB-donor-CU to the mobile IAB-node, a Downlink (DL) RRC Message Transfer message including the RRC reconfiguration message.

6. The method of claim 1,
wherein the information on the UAV Capability of the mobile IAB-node is transmitted from a DU of the mobile IAB-node by being included in an F1 message.

7. The method of claim 6,
wherein the F1 message includes an F1 Setup Request message.

8. The method of claim 1,
wherein the information on the UAV Capability of the mobile IAB-node is transmitted from a mobile termination (MT) of the mobile IAB-node by being included in an RRC message.

9. The method of claim 1, wherein the method further comprises,
determining, by the IAB-donor-CU, the flying state of the mobile IAB-node based on measurements report provided from the mobile IAB-node.

10. The method of claim 9,
wherein the measurements report includes information on altitude of the mobile IAB-node.

11. The method of claim 1, wherein the method further comprises,
receiving, by the IAB-donor-CU from the mobile IAB-node, a moving indication informing that the mobile IAB-node starts flight.

12. The method of claim 11,
wherein the moving indication is included in the gNB-DU Configuration Update message.

13. The method of claim 1, wherein the IAB-donor-CU is in communication with at least one of a user equipment, a network, or an autonomous vehicle other than the wireless device.

14. An Integrated Access and Backhaul (IAB)-donor-Central Unit (CU), comprising:
a memory; and
at least one processor operatively coupled to the memory, and configured to:
initiate an integration procedure with a mobile IAB-node;
perform an IAB-MT setup procedure with the mobile IAB-node;
perform a backhaul radio link control (BH RLC) channel establishment with the mobile IAB-node;
perform a routing update with the mobile IAB-node;
perform an IAB-Distributed Unit (DU) setup procedure with the mobile IAB-node;
receive, from the mobile IAB-node, information on an Unmanned Aerial Vehicle (UAV) Capability of the mobile IAB-node, in the integration procedure;
transmit, to the mobile IAB-node, a UE Context Setup Request message including information on a flying state for a UE;
receive, from the mobile IAB-node, a gNB-DU Configuration Update message including information on whether the mobile IAB-node is in flight; and
transmit, to the UE through the mobile IAB-node, (i) an RRC message including a measurement stop indication, and/or (2) an RRC message without information related to measurements.

15. The IAB-donor-CU of claim 14, wherein the at least one processor is further configured to,
receive, from the mobile IAB-node, a UE Context Setup Response message including information on the flying state for the UE.

16. The IAB-donor-CU of claim 14, wherein the at least one processor is further configured to,
transmit, to the mobile IAB-node, a gNB-DU Configuration Update Acknowledgement message.

17. The IAB-donor-CU of claim 14,
wherein (i) the RRC message including a measurement stop indication, and/or (2) the RRC message without information related to measurements is an RRC reconfiguration message.

18. The IAB-donor-CU of claim 17, wherein the at least one processor is further configured to,
transmit, to the mobile IAB-node, a Downlink (DL) RRC Message Transfer message including the RRC reconfiguration message.

19. The IAB-donor-CU of claim 14,
wherein the information on the UAV Capability of the mobile IAB-node is transmitted from a DU of the mobile IAB-node by being included in an F1 message.

20-28. (canceled)

29. A method, comprising,
receiving, by a wireless device from an Integrated Access and Backhaul (IAB)-donor-Central Unit (CU) through a mobile IAB-node, (i) an RRC message including a measurement stop indication, and/or (2) an RRC message without information related to measurements,
wherein the IAB-donor CU initiates an integration procedure with the mobile IAB-node,
wherein the IAB-donor CU receives, from the mobile IAB-node, information on an Unmanned Aerial Vehicle (UAV) Capability of the mobile IAB-node, in the integration procedure,
wherein the IAB-donor CU transmits, to the mobile IAB-node, a UE Context Setup Request message including information on a flying state for the wireless device, and
wherein the IAB-donor CU receive, from the mobile IAB-node, a gNB-DU Configuration Update message including information on whether the mobile IAB-node is in flight, based on the information on the flying state of the mobile IAB-node being changed, and
wherein the IAB-donor CU generates (i) the RRC message including the measurement stop indication, and/or (2) the RRC message without the information related to measurements.

30. (canceled)
